(19) United States
(12) Patent Application Publication
(10) Pub. No.: US 2014/0247202 A1
(43) Pub. Date: Sep. 4, 2014

(54) LEVEL CONVERSION CIRCUIT, MULTI-VALUE OUTPUT DIFFERENTIAL AMPLIFIER, AND DISPLAY UNIT

(71) Applicant: Sony Corporation, Tokyo (JP)

(72) Inventor: Hayato Kamizuru, Kagoshima (JP)

(73) Assignee: Sony Corporation, Tokyo (JP)

(21) Appl. No.: 14/189,450

(22) Filed: Feb. 25, 2014

(30) Foreign Application Priority Data
Mar. 4, 2013 (JP) 2013-042090

(51) Int. Cl. G09G 3/20; G09G 3/36

(52) U.S. Cl. CPC G09G 3/2007; G09G 3/36
USPC 345/89

(57) ABSTRACT

A level conversion circuit includes: a multi-value output differential amplifier circuit including an inverting input section, an output section, and two or more non-inverting input sections; and an offset cancelling circuit configured to store, on each of a plurality of capacitors, an offset voltage that arises on each of the two or more non-inverting input sections of the multi-value output differential amplifier circuit, and subtract the offset voltages from an output voltage of the output section.

### CROSS REFERENCE TO RELATED APPLICATIONS

This application claims the benefit of Japanese Priority Patent Application JP 2013-042090 filed on Mar. 4, 2013, the entire contents of which are incorporated herein by reference.

### BACKGROUND

The present technology relates to a level conversion circuit, a multi-value output differential amplifier, and a display unit.

In recent years, a multi-level gradation display has been advanced in a display unit such as a liquid crystal display, and to take a 12-bit liquid crystal display as an example, a multi-level gradation display using as many as 4,096 gradation levels (about 68.7 billion colors) is necessary. In a display unit corresponding to such a multi-level gradation display, generation of all the gradation levels by the use of a digital-to-analog converter (DAC) would cause an increase in the circuit area of the DAC.

Accordingly, as a general rule, a bit conversion function is assigned to be divided between a DAC and a differential amplifier for amplifying a DAC output. For example, a bit conversion function for upper 9 bits may be assigned to the DAC, while a bit conversion function for lower 3 bits may be assigned to the differential amplifier.

However, if an output voltage range to be used for a gradation voltage is 18 V, a change in voltage per gradation in a case of 12-bit gradation may be as small as about 4 mV, and thus it is necessary for a multi-value output differential amplifier to provide a high-accuracy voltage output.

However, a differential amplifier generates an output offset that is caused mainly by variations in the characteristics of active elements. It is difficult to eliminate such variations in the characteristics completely because they are attributable to variations in oxide films of MOS transistors or impurity concentration, or variations in the device size (W (gate width)/L (gate length)), or the like.

In view of such circumstances, various measures have been proposed that enable a high-accuracy output to be provided by eliminating any output offset in a differential amplifier (for example, see Japanese Unexamined Patent Application Publication Nos. 2007-259114, 2007-096504, 2007-089074, and 2005-286615).

### SUMMARY

Meanwhile, unlike methods proposed in Japanese Unexamined Patent Application Publication Nos. 2007-259114, 2007-096504, 2007-089074, and 2005-286615, a capacitance storage method has been typically available as a method for accurately correcting an offset in a differential amplifier. The capacitance storage method, which utilizes an offset cancelling circuit, cancels any offset in a manner of storing an offset voltage as a difference between an input voltage and an output voltage on a capacitor and performing an arithmetic operation of such an offset voltage in conjunction with the input voltage.

However, when an attempt is made to apply such offset cancelling circuit to a multi-value output differential amplifier, a possible issue of deterioration in the accuracy may arise.

It is desirable to accurately correct an output offset in a multi-value output differential amplifier utilizing a capacitance storage method.

According to an embodiment of the present technology, there is provided a level conversion circuit including: a multi-value output differential amplifier circuit including an inverting input section, an output section, and two or more non-inverting input sections; and an offset cancelling circuit configured to store, on each of a plurality of capacitors, an offset voltage that arises on each of the two or more non-inverting input sections of the multi-value output differential amplifier circuit, and subtract the offset voltages from an output voltage of the output section.

The technology encompasses various embodiments, including embodiments where such a level conversion circuit is implemented in a state of being incorporated into any other apparatuses or in combination with any other methods. Further, the present technology may be embodied as a multi-value output differential amplifier with the built-in level conversion circuit, or an electronic apparatus such as a liquid crystal display unit using the level conversion circuit or the multi-value output differential amplifier at an output stage.

According to an embodiment of the present technology, there is provided a multi-value output differential amplifier including: an inverting input section; an output section; two or more non-inverting input sections; a plurality of capacitors that are as many as the two or more non-inverting input sections and provided corresponding to the two or more non-inverting input sections, and each having a first end connected with the inverting input section; a first switching section configured to switch a connection point of a second end of each of the capacitors between corresponding one of the two or more non-inverting input sections and the output section; a second switching section configured to connect or disconnect a connection between the inverting input section and the output section; a plurality of differential signal generation sections that are provided corresponding to the two or more non-inverting input sections, and each configured to generate a differential signal that is a differential between an input signal applied to corresponding one of the two or more non-inverting input sections and an input signal applied to the inverting input section; and an amplifier section configured to amplify, at a predetermined gain, an additional value signal that is an addition of the differential output signals outputted from the differential signal generation sections, and output the amplified additional value signal to the output section.

According to an embodiment of the present technology, there is provided a display unit configured to drive display elements at gradation voltages generated by a level conversion circuit. The level conversion circuit includes: a multi-value output differential amplifier circuit including an inverting input section, an output section, and two or more non-inverting input sections; and an offset cancelling circuit configured to store, on each of a plurality of capacitors, an offset voltage that arises on each of the two or more non-inverting input sections of the multi-value output differential amplifier circuit, and subtract the offset voltages from an output voltage of the output section.

According to the above-described embodiments of the present technology, it is possible to accurately correct the output offset in the multi-value output differential amplifier utilizing the capacitance storage method.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present technology.

FIG. 1 is a schematic block diagram showing a configuration of a level conversion circuit according to a first embodiment of the present technology.

FIG. 2 is a circuit diagram showing a specific example of the level conversion circuit.

FIG. 3 is a circuit diagram showing an internal configuration example of a multi-value output differential amplifier.

FIG. 4 is a circuit diagram in a state of storage of an offset voltage.

FIG. 5 is a circuit diagram in a state of output of an offset voltage.

FIGS. 6A and 6B are each a table showing a simulation result of an output voltage.

FIG. 7 is a schematic block diagram showing a configuration example of a typical signal line driving circuit.

FIG. 8 is a circuit in which an offset cancelling circuit is applied to a multi-value output differential amplifier according to a comparative example.

### DETAILED DESCRIPTION

Hereinafter, some embodiments of the present technology are described in the order given below.

### (A) First Embodiment

### (B) Second Embodiment

### (C) Third Embodiment

### (D) Conclusion

Before describing example embodiments of the present technology, a comparative example is discussed in the following.

A capacitance storage method has been typically available as a method for accurately correcting an offset in a differential amplifier. The capacitance storage method, which utilizes an offset cancelling circuit, cancels any offset in a manner of storing an offset voltage as a difference between an input voltage and an output voltage on a capacitor and performing an arithmetic operation of such an offset voltage in conjunction with the input voltage.

However, when an attempt is made to apply such offset cancelling circuit to a multi-value output differential amplifier, a possible issue of deterioration in the accuracy may arise as described below.

FIG. 8 is a circuit according to a comparative example in which an offset cancelling circuit employing a capacitance storage method is applied to a multi-value output differential amplifier. The multi-value output differential amplifier has a plurality of input lines depending on a resolution thereof. Accordingly, an offset voltage is not determined in a state of different input voltages for each input line, and thus it is necessary to store the offset voltage on a capacitor after once fixing the input voltages for all the input lines to certain voltages.

In such a case, because the input voltage to be applied to the input line at the time of storage of the offset voltage is different from that at the time of output of the offset voltage, the varied voltage is divided in capacitance by a capacitor for offset storage and a parasitic capacitor at an input section, causing the offset voltage stored on the capacitor to be changed. As a result, an error may occur in the output voltage.

What is therefore desired is a technology that accurately corrects an output offset in a multi-value output differential amplifier utilizing a capacitance storage method.

### (A) FIRST EMBODIMENT

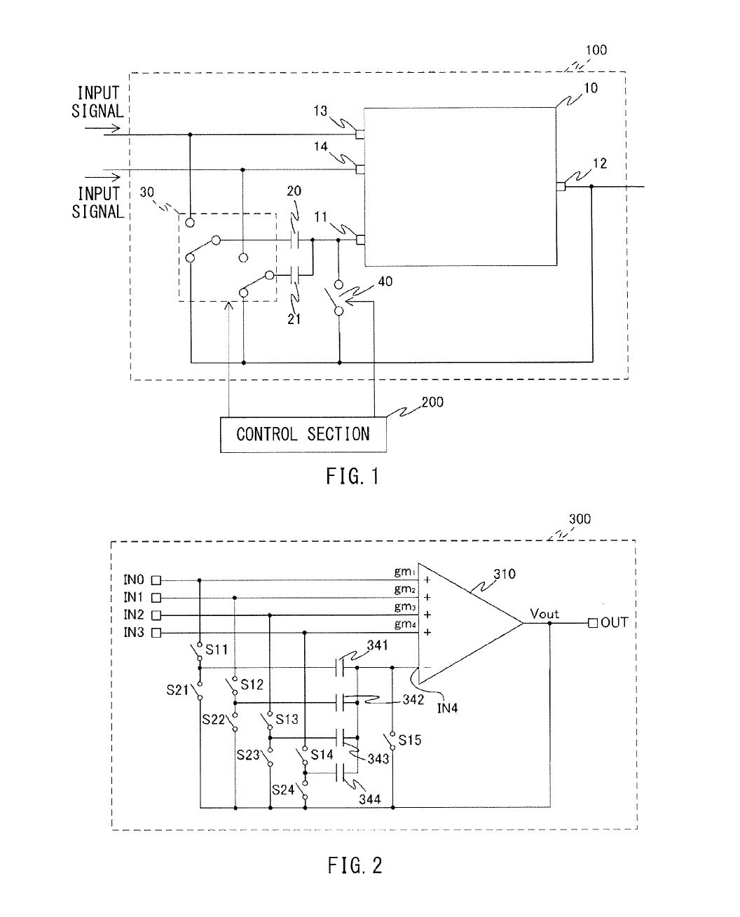

FIG. 1 is a schematic block diagram showing a configuration of a level conversion circuit according to a first embodiment of the present technology. In FIG. 1, a level conversion circuit 100 includes a multi-value output differential amplifier 10, a plurality of capacitors 20 and 21, a first switching section 30, and a second switching section 40.

The multi-value output differential amplifier 10 includes an inverting input section 11, an output section 12, and non-inverting input sections 13 and 14. The number of the non-inverting input sections may be set to any number of two or more. Further, the number of the capacitors may be also set to any number of two or more in accordance with the number of the non-inverting input sections.

The multi-value output differential amplifier 10 uses a differential signal between an input signal to be applied to the inverting input section 11 and an input signal to be applied to the non-inverting input section 13 as a first differential input, and a differential signal between an input signal to be applied to the inverting input section 11 and an input signal to be applied to the non-inverting input section 14 as a second differential input, providing an output signal in accordance with these differential inputs from the output section 12.

In other words, a variety of output signal is provided from the output section 12 depending on a combination of the differential inputs. For example, if an input signal to be applied to the inverting input section 11 has a fixed value, and each of input signals to be applied to the non-inverting input sections 13 and 14 takes a binary value (for example, on/off binary value), the output section 12 is capable of providing four types of output signal depending on a combination of the input signals.

For the capacitor 20, a first end thereof is connected with the inverting input section 11. Similarly, for the capacitor 21 as well, a first end thereof is also connected with the inverting input section 11.

The first switching section 30 switches a connecting point of a second end of the capacitor 20 between the non-inverting input section 13 and the output section 12, and a connecting point of a second end of the capacitor 21 between the non-inverting input section 14 and the output section 12.

The inverting input section 11 is connected with the output section 12 via the second switching section 40. The second switching section 40 switches connection/disconnection between the inverting input section 11 and the output section 12.

Each of capacitances C1 and C2 of the capacitors 20 and 21 is set at a value in accordance with a gain of the corresponding non-inverting input section, and a ratio of the capacitance C1 to the capacitance C2 is equivalent to a ratio of a gain gm1 of the non-inverting input section 13 to a gain gm2 of the non-inverting input section 14. Consequently, when each of the capacitors 20 and 21 is connected with the corresponding non-inverting input section and the output section 12, each of the capacitors 20 and 21 accumulates a charge depending on a gain of the corresponding non-inverting input section and an input signal level.

The level conversion circuit 100 that is configured in such a manner, which is under control of a control section 200, carries out a control to switch a state thereof between a first state and a second state as appropriate by controlling the first switching section 30 and the second switching section 40.

The first state is a state where the first switching section 30 connects each of the second ends of the capacitors 20 and 21 with the corresponding non-inverting input section, and the second switching section 40 connects the inverting input section 11 with the output section 12. More specifically, the first state is a state where a connection is made between the inverting input section 11 and the output section 12, and a connection is made between the non-inverting input section 13 and the inverting input section 11 via the capacitor 20, while a connection is made between the non-inverting input section 14 and the inverting input section 11 via the capacitor 21.

The second state is a state where the first switching section 30 connects each of the second ends of the capacitors 20 and 21 with the output section 12, and the second switching section 40 makes a disconnection between the inverting input section 11 and the output section 12. More specifically, the second state is a state where a disconnection is made between the inverting input section 11 and the output section 12, and a connection is made between the inverting input section 11 and the output section 12 via the capacitor 20, while a connection is made between the inverting input section 11 and the output section 12 via the capacitor 21.

According to the level conversion circuit 100 as described above, in such a manner that the control section 200 controls the first switching section 30 and the second switching section 40, it is possible to store an offset voltage between each of the non-inverting input sections 13 and 14 and the output section 12 on each of the capacitors 20 and 21, while applying a different and intended input signal to each of the non-inverting input sections 13 and 14, and thereafter to apply an additional value of this stored offset voltage between the inverting input section 11 and the output section 12.

In a multi-value output differential amplifier circuit having a plurality of input lines (non-inverting input sections), this allows an offset cancelling operation in a capacitance storage method to be performed with each input signal placed in the same state as that at the time of output (in a state of different voltage for each input). As a result, this makes it possible to achieve the high-accuracy offset cancellation without any influence of voltage variation and a parasitic capacitance in an input section on a stored offset voltage.

### (B) SECOND EMBODIMENT

Next, as a second embodiment of the present technology, the description is provided on an example of a more specific configuration of a level conversion circuit. FIG. 2 is a circuit diagram showing a specific example of the level conversion circuit. FIG. 2 illustrates by an example a level conversion circuit 300 utilizing a 3-bit multi-value output differential amplifier circuit.

The level conversion circuit 300 illustrated in FIG. 2 includes a multi-value output differential amplifier circuit 310 having positive input terminals IN0 to IN3, a negative input terminal IN4, and an output terminal OUT, as well as switches S11 to S15 and S21 to S24, and capacitors 341 to 344. On/off switching for each of the switches S11 to S15 and S21 to S24 is controlled as appropriate by an external control section (not shown in the drawing) and the like.

In the multi-value output differential amplifier circuit 310, a gain for each input on the input terminals IN0 to IN3 is weighted properly to achieve a 3-bit gradation level from an output voltage Vout. In concrete terms, a size of a MOS transistor that configures a differential signal generation circuit to generate a differential signal for the input on each of the input terminals IN0 to IN3 is adjusted to be a proper ratio.

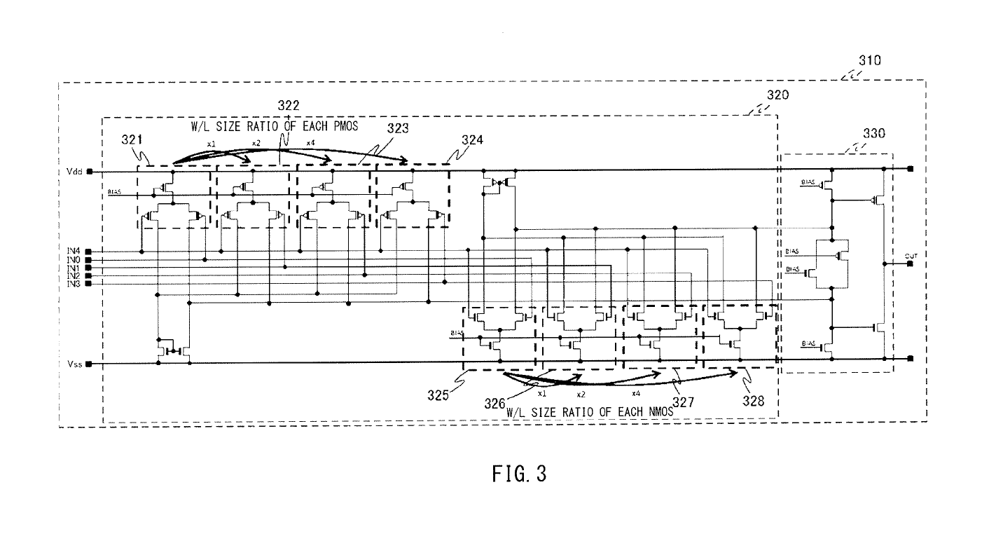

FIG. 3 is a circuit diagram showing an internal configuration example of the multi-value output differential amplifier circuit 310. The multi-value output differential amplifier circuit 310 illustrated in FIG. 3 includes a differential stage 320 and an amplifying stage 330 as an amplifier section.

The differential stage 320 includes differential signal generation sections 321 to 324 each of which is configured of a PMOS transistor served as a first conductivity-type MOS transistor, and differential signal generation sections 325 to 328 each of which is configured of an NMOS transistor served as a second conductivity-type MOS transistor.

The differential signal generation section 321 generates a differential signal between the input terminal IN0 and the input terminal IN4, and the differential signal generation section 322 generates a differential signal between the input terminal IN1 and the input terminal IN4. Similarly, the differential signal generation section 323 generates a differential signal between the input terminal IN2 and the input terminal IN4, and the differential signal generation section 324 generates a differential signal between the input terminal IN3 and the input terminal IN4.

For the PMOS transistors that configure the differential signal generation sections 321 to 324, a size ratio of W (gate width)/L (gate length) is weighted. Given that W/L sizes of the differential signal generation sections 321, 322, 323, and 324 are W₁, W₂, W₃, and W₄, respectively, a relationship represented by Expression (1) given below is established.

W₁:W₂:W₃:W₄=1:1:2:4 (1)

In the same manner, the differential signal generation section 325 generates a differential signal between the input terminal IN0 and the input terminal IN4, and the differential signal generation section 326 generates a differential signal between the input terminal IN1 and the input terminal IN4. Similarly, the differential signal generation section 327 generates a differential signal between the input terminal IN2 and the input terminal IN4, and the differential signal generation section 328 generates a differential signal between the input terminal IN3 and the input terminal IN4.

Also for the NMOS transistors that configure the differential signal generation sections 325 to 328, a size ratio of W/L is weighted. Given that W/L sizes of the differential signal generation sections 325, 326, 327, and 328 are W₅, W₆, W₇, and W₈, respectively, a relationship represented by Expression (2) given below is established.

W₅:W₆:W₇:W₈=1:1:2:4 (2)

In such a manner, the above-described weighting is achieved by properly adjusting a size ratio of W/L for the MOS transistor that configures each of the differential signal generation sections.

It is to be noted that FIG. 3 illustrates by an example the multi-value output differential amplifier circuit 310 that combines the differential signal generation sections configured of the PMOS transistors and the differential signal generation sections configured of the NMOS transistors, although a multi-value output differential amplifier circuit according to an embodiment of the present technology is not limited thereto, and any other various multi-value output differential amplifier circuits may be alternatively used as a matter of course.

In a circuit shown in FIG. 2, gains gm₁ to gm₄ for the respective input terminals IN0 to IN3, that is, a transconductance of a differential circuit being connected with each of the input terminals IN0 to IN3 may be allowed to be set up as represented by Expression (3) given below, for example. A proper weighting of a gain for each of the input terminals IN0 to IN3 allows an output of linear 8 values (3 bits) to be provided for a binary input (presence of input/absence of input) for each of the input terminals IN0 to IN3.

$$\begin{matrix}\begin{matrix}\begin{matrix}{gm}_{1} = 1 \times {gm}_{1} \\ {gm}_{2} = 1 \times {gm}_{1}\end{matrix} \\ {gm}_{3} = 2 \times {gm}_{1}\end{matrix} \\ {gm}_{4} = 4 \times {gm}_{1}\end{matrix} \} \qquad ( 3 )$$

When a gain is set up for each of the input terminals IN0 to IN3, a capacitance for each of the capacitors 341 to 344 is weighted at the same ratio as with each of the gains gm₁ to gm₄ as represented by Expression (4) given below. This makes it possible to carry out the high-accuracy offset cancellation, thereby allowing to output a voltage with a reduced error that is substantially equivalent to a theoretical value.

$$\begin{matrix}\begin{matrix}\begin{matrix}{C}_{1} = 1 \times {C}_{1} \\ {C}_{2} = 1 \times {C}_{1}\end{matrix} \\ {C}_{3} = 2 \times {C}_{1}\end{matrix} \\ {C}_{4} = 4 \times {C}_{1}\end{matrix} \} \qquad ( 4 )$$

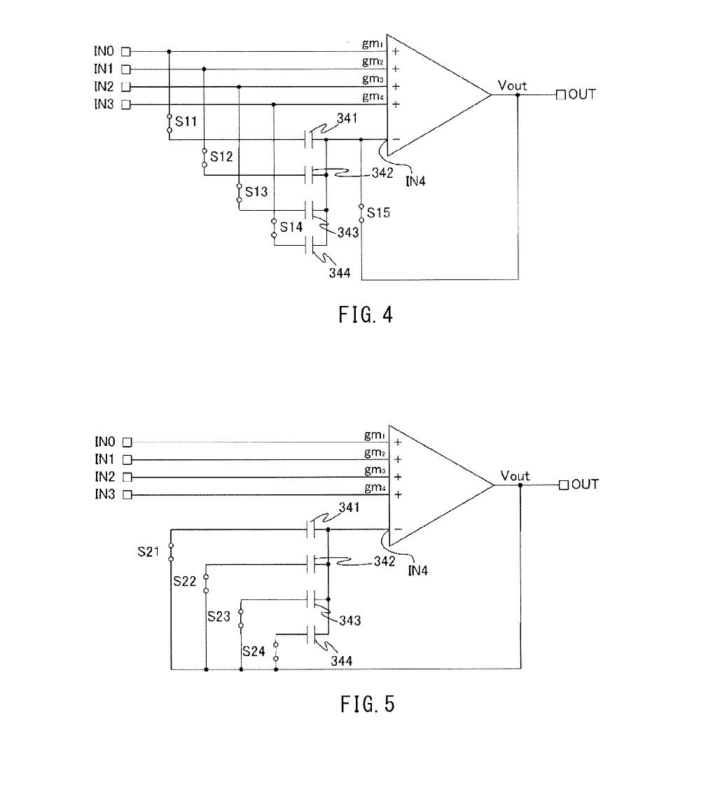

Next, with reference to FIG. 4 and FIG. 5, the description is provided on the high-accuracy offset cancellation that is achieved when the gain and capacitance are set up as represented by Expressions (3) and (4). FIG. 4 is a circuit diagram in a state of storage of an offset voltage, while FIG. 5 is a circuit diagram in a state of output of an offset voltage.

First, in a state of storage of an offset voltage as shown in FIG. 4, the switches S11 to S14 are turned ON, while the switches S21 to S24 are turned OFF, and a desired voltage is applied to each of the input terminals IN0 to IN3. It is to be noted that, in FIG. 4, illustration of the switches S21 to S24 that are turned OFF are omitted to clarify a connecting relationship.

In this case, an output voltage Vout that is represented by Expression (5) given below is output on the output terminal OUT. In Expression (5) given below, voltages Vin1 to Vin4 denote voltages to be applied to the input terminals IN0 to IN3, respectively, and ΔV denotes an offset voltage arising in an overall circuit.

$$Vout = \frac{( 1 \times Vin 1 + 1 \times Vin 2 + 2 \times Vin 3 + 4 \times Vin 4 )}{8} + Δ V \qquad ( 5 )$$

Further, as represented by Expression (6) given below, charges Q₁ to Q₄ in accordance with offset voltages related to the input terminals IN0 to IN3 (difference voltages ΔV1 to ΔV4 between each voltage being applied to the corresponding input terminal and the output voltage Vout) and capacitances C₁ to C₄ of respective capacitors are accumulated on each of the capacitors 341 to 344.

$$\begin{matrix}\begin{matrix}\begin{matrix}{Q}_{1} = {C}_{1} \times Δ V 1 = {C}_{1} \times ( Vout - Vin 1 ) \\ {Q}_{2} = {C}_{2} \times Δ V 2 = {C}_{2} \times ( Vout - Vin 2 ) = {C}_{1} \times ( Vout - Vin 2 )\end{matrix} \\ {Q}_{3} = {C}_{3} \times Δ V 3 = {C}_{3} \times ( Vout - Vin 3 ) = 2 \times {C}_{1} \times ( Vout - Vin 3 )\end{matrix} \\ {Q}_{4} = {C}_{4} \times Δ V 4 = {C}_{4} \times ( Vout - Vin 4 ) = 4 \times {C}_{1} \times ( Vout - Vin 4 )\end{matrix} \} \qquad ( 6 )$$

More specifically, a total of the charges accumulated on each of the capacitors 341 to 344, that is, Qₜₒₜₐₗ is represented by Expression (7) given below.

$$\begin{matrix}{Q}_{total} = {Q}_{1} + {Q}_{2} + {Q}_{3} + {Q}_{4} \\ = {C}_{1} \times ( Vout - Vin 1 ) + {C}_{2} \times ( Vout - Vin 2 ) + \\ {C}_{3} \times ( Vout - Vin 3 ) + {C}_{4} \times ( Vout - Vin 4 ) \\ = ( {C}_{1} + {C}_{2} + {C}_{3} + {C}_{4} ) \times Vout - \\ ( {C}_{1} \times Vin 1 + {C}_{2} \times Vin 2 + {C}_{3} \times Vin 3 + {C}_{4} \times Vin 4 ) \\ = {C}_{1} \times ( 8 \times Vout - Vin 1 - Vin 2 - 2 \times Vin 3 - 4 \times Vin 4 )\end{matrix} \qquad ( 7 )$$

Next, in a state of output of an offset voltage as shown in FIG. 5, the switches S11 to S14 are turned OFF, while the switches S21 to S24 are turned ON, and a desired voltage is applied to each of the input terminals IN0 to IN3. It is to be noted that, in FIG. 5, illustration of the switches S11 to S14 that are turned OFF are omitted to clarify a connecting relationship.

In this case, a total of capacitances of the capacitors 341 to 344, that is, Cₜₒₜₐₗ is represented by Expression (8) given below because the capacitors 341 to 344 are connected in parallel with each other.

$$\begin{matrix}{C}_{total} = {C}_{1} + {C}_{2} + {C}_{3} + {C}_{4} \\ = {C}_{1} + 1 \times {C}_{1} + 2 \times {C}_{2} + 3 \times {C}_{3} \\ = 8 \times {C}_{1}\end{matrix} \} \qquad ( 8 )$$

Further, a voltage V_{cap} arising in the capacitors 341 to 344 is represented by Expression (9) given below.

$$\begin{matrix}{V}_{cap} = \frac{{Q}_{total}}{{C}_{total}} \\ = \frac{{C}_{1} \times ( 8 \times Vout - Vin 1 - Vin 2 - 2 \times Vin 3 - 4 \times Vin 4 )}{8 \times {C}_{1}} \\ = Vout - \frac{1 \times Vin 1 + 1 \times Vin 2 + 2 \times Vin 3 + 4 \times Vin 4}{8} \\ = Vout - ( Vout - Δ V ) \\ = Δ V\end{matrix} \qquad ( 9 )$$

Additionally, an output voltage on this occasion is represented by Expression (10) given below.

$$\begin{matrix}Vout = \frac{1 \times Vin 1 + 1 \times Vin 2 + 2 \times Vin 3 + 4 \times Vin 4}{8} + Δ V - {V}_{cap} \\ = \frac{1 \times Vin 1 + 1 \times Vin 2 + 2 \times Vin 3 + 4 \times Vin 4}{8}\end{matrix} \qquad ( 10 )$$

More specifically, it can be seen therefrom that the offset voltage ΔV is cancelled, and a desired output voltage is provided. As described above, the high-accuracy offset cancelling circuit according to this embodiment of the present technology allows for accurate correction of any output offset using only the desired input voltage without the necessity for keeping the input voltages for the multi-value output differential amplifier in line with each other. As a result, this makes it possible to achieve the high-accuracy offset cancellation without any influence of variations in the input voltages on the offset voltage.

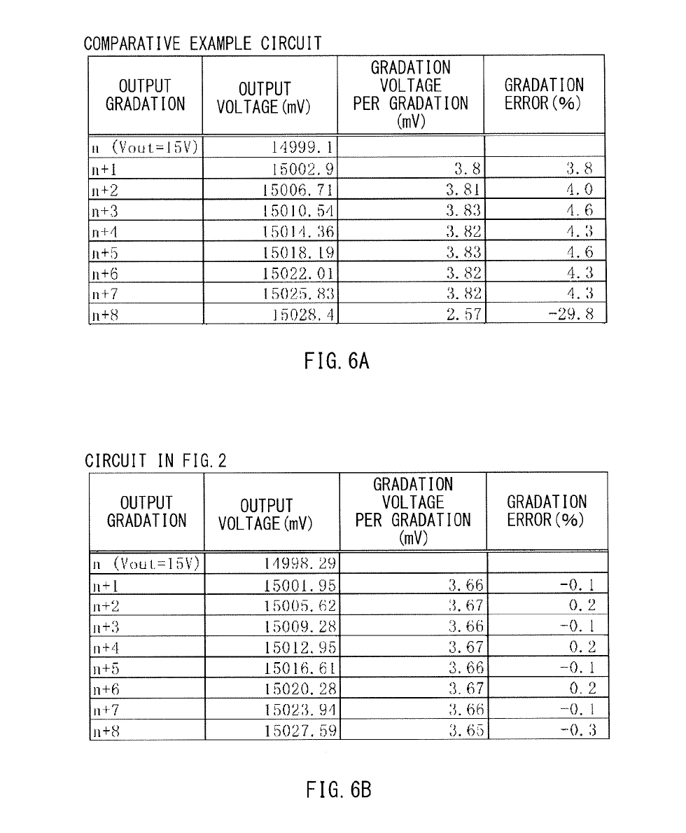

Each of FIGS. 6A and 6B shows a simulation result of output voltages. FIG. 6A shows a simulation result of output voltages for the case of a multi-value output differential amplifier circuit to which an offset cancelling circuit according to a comparative example illustrated in FIG. 8 is applied, and FIG. 6B shows a simulation result of output voltages for the case of the circuit illustrated in FIG. 2.

As shown in FIG. 6A, in the case of the multi-value output differential amplifier circuit to which an offset cancelling circuit according to a comparative example is applied, an error in the order of about 4% occurred per gradation, and a total error of as much as about 30% occurred at the seventh gradation. On the contrary, as shown in FIG. 6B, in the case of provision of the output offset correction circuit according to this embodiment of the present technology, it is seen that an error was almost eliminated, and the output offset was corrected highly accurately.

It is to be noted that such an output offset correction is applicable to any system using a multi-value output differential amplifier. For example, if such an output offset correction is applied to a display data driver, it is possible to provide an output with high gradation performance while keeping the number of the gradation levels. Hereinafter, the description is provided on an example where the present technology is applied to a display data driver.

### (C) THIRD EMBODIMENT

In a third embodiment of the present technology, the description is provided on an electronic apparatus using any of the level conversion circuits 100 and 300 according to the above-described first and second embodiments of the present technology. In this embodiment of the present technology, the description is provided by taking a liquid crystal display unit as an example of the electronic apparatus. In this liquid crystal display unit, the level conversion circuits 100 and 300 according to the above-described first and second embodiments of the present technology are used for a buffer amplifier for a data driver to drive data lines.

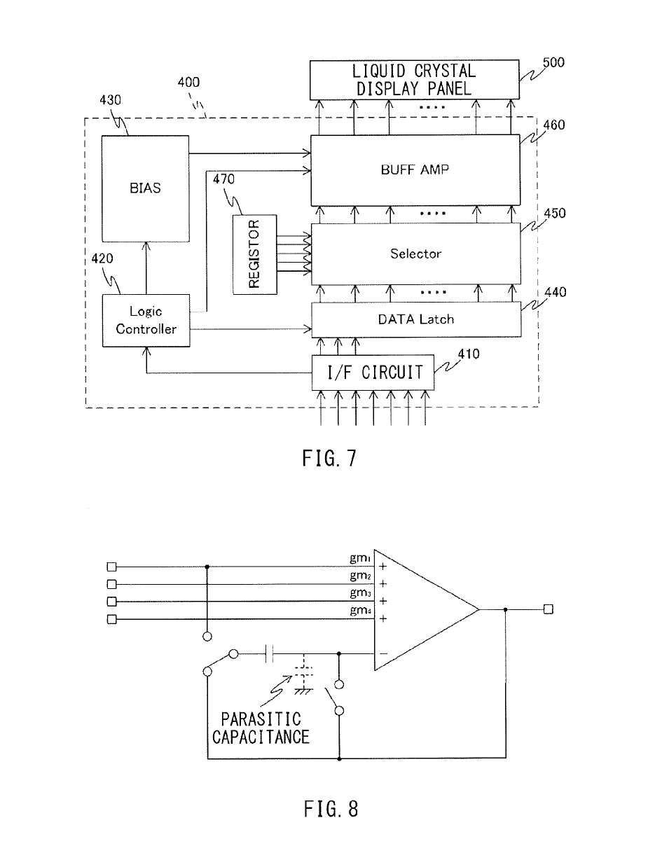

FIG. 7 is a schematic block diagram showing a configuration example of a typical signal line driving circuit. A signal line driving circuit 400 illustrated in FIG. 7 has an interface (I/F) circuit 410, a control logic section 420, a bias section 430, a data latch 440, a selector circuit 450, a buffer amplifier 460, and a gradation resistive circuit 470.

The signal line driving circuit 400 is used as a so-called source driver IC for a liquid crystal display panel 500. In the signal line driving circuit 400, the analog buffer amplifier section 460 is used for an output circuit to a pixel as a display element for the liquid crystal display panel 500.

A control signal and an image data signal are received at the I/F circuit 410, and are provided to the selector circuit 450 for a gradation voltage via the control logic section 420 and the data latch 440.

The selector circuit 450 selects a desired analog voltage corresponding to image data from among gradation voltages that are generated by the gradation resistive circuit 470 to provide the selected analog voltage to the analog buffer amplifier section 460, which performs an impedance conversion for driving a load. As described above, an output stage of the signal line driving circuit 400 is provided with a digital-to-analog conversion functionality.

The control logic section 420 carries out a control to latch the image data incoming into the data latch 440 from the I/F circuit 410 on the basis of control data incoming from the I/F circuit 410. Further, the control logic section 420 also controls a biasing state of an amplifier at an output stage of the buffer amplifier section 460.

The bias section 430 selectively outputs a bias signal of an amplifier at an output stage of the buffer amplifier section 460 under the control of the control logic section 420.

The data latch 440 latches the image data incoming from the I/F circuit 410 under the control of the control logic section 420. The image data that is latched by the data latch 440 is used as drive data for driving signal lines.

The selector circuit 450, to which a plurality of gradation voltages are inputted from the gradation resistive circuit 470, provides a plurality of gradation voltages that are selected as appropriate from among the plurality of gradation voltages delivered from the gradation resistive circuit 470 to respective non-inverting input terminals of buffer amplifiers in the buffer amplifier section 460.

It is to be noted that because the above-described level conversion circuits 100 and 300 each have four non-inverting input terminals, the selector circuit 450 selects four gradation voltages necessary for outputting the gradation voltages corresponding to the gradation levels of the incoming image data from among a plurality of gradation voltages that are generated by the gradation resistive circuit 470 to provide these selected gradation voltages to the buffer amplifier as the input.

The selector circuit 450 prestores a correspondence relation between gradation values of the image data and four gradation voltages to be applied to the non-inverting input terminals of the buffer amplifier to output the gradation voltages corresponding to the gradation values. With reference to such a correspondence relation, the selector circuit 450 properly selects four gradation voltages depending on the image data incoming from the data latch 440 to output these selected gradation voltages to each of the non-inverting input terminals of the buffer amplifier.

The buffer amplifier section 460 generates an output voltage Vout that divides the plurality of gradation voltages selected and inputted by the selector circuit 450. The output voltage Vout corresponds to any one of gradation voltages for n-bit gradation level.

More specifically, the gradation resistive circuit 470 outputs the gradation voltages corresponding to predetermined upper m bits out of n-bit image data (m<n), and takes charge of a bit conversion function for the upper m bits. On the other hand, the buffer amplifier section 460 outputs the gradation voltages corresponding to all of n bits of n-bit image data signal, and takes charge of a bit conversion function for the lower (n−m) bits.

This allows the buffer amplifier section 460 to generate the gradation voltages of all the levels assignable by the image data. With the gradation voltages that are generated by cancelling the offset voltage with a high degree of accuracy in such a manner, each pixel configuring the liquid crystal display panel 500 is driven. As a result, the liquid crystal display panel 500 carries out a display with the multi-level gradation and high gradation performance.

### (D) CONCLUSION

As described thus far, an embodiment of the present technology includes the multi-value output differential amplifier circuit and the offset cancelling circuit. The multi-value output differential amplifier circuit includes the inverting input section, the output section, and the two or more non-inverting input sections. The offset cancelling circuit is configured to store, on the capacitor, the offset voltage that arises on each of the two or more non-inverting input sections of the multi-value output differential amplifier circuit, and subtract the offset voltage from the output voltage of the output section. This makes it possible to provide an output voltage in which any output offset in the multi-value output differential amplifier circuit is highly accurately corrected using the capacitance storage method.

It is to be noted that the present technology is not limited to the above-described embodiments and modification examples, but may also involve configurations that replace each of the configurations disclosed in the above-described embodiments and modification examples with one other or change a combination thereof, or configurations that replace each of the configurations disclosed in a known technology as well as the above-described embodiments and modification examples with one other or change a combination thereof, and the like. Further, the technical scope of the present technology is not limited to the above-described embodiments, but covers elements and matters described in the appended claims and the equivalents thereof.

Furthermore, the technology encompasses any possible combination of some or all of the various embodiments described herein and incorporated herein.

It is possible to achieve at least the following configurations from the above-described example embodiments of the disclosure.

(1) A level conversion circuit, including:

a multi-value output differential amplifier circuit including an inverting input section, an output section, and two or more non-inverting input sections; and

an offset cancelling circuit configured to store, on each of a plurality of capacitors, an offset voltage that arises on each of the two or more non-inverting input sections of the multi-value output differential amplifier circuit, and subtract the offset voltages from an output voltage of the output section.

(2) The level conversion circuit according to (1), wherein the offset cancelling circuit includes:

the plurality of capacitors that are as many as the two or more non-inverting input sections and provided corresponding to the two or more non-inverting input sections, and each having a first end connected with the inverting input section;

a first switching section configured to switch a connection point of a second end of each of the capacitors between corresponding one of the two or more non-inverting input sections and the output section; and

a second switching section configured to connect or disconnect a connection between the inverting input section and the output section.

(3) The level conversion circuit according to (2), wherein the multi-value output differential amplifier circuit includes:

a plurality of differential signal generation sections that are provided corresponding to the two or more non-inverting input sections, and each configured to generate a differential signal that is a differential between an input signal applied to corresponding one of the two or more non-inverting input sections and an input signal applied to the inverting input section; and

an amplifier section configured to amplify, at a predetermined gain, an additional value signal that is an addition of the differential output signals outputted from the differential signal generation sections, and output the amplified additional value signal to the output section.

(4) The level conversion circuit according to (2) or (3), further including a control section configured to control the first switching section and the second switching section to make a switching between a first state and a second state, wherein

the first state is a state in which the first switching section connects the second ends of the capacitors with the respective two or more non-inverting input sections, and in which the second switching section connects the inverting input section with the output section, and

the second state is a state in which the first switching section connects each of the second ends of the capacitors with the output section, and in which the second switching section disconnects the connection between the inverting input section and the output section.

(5) The level conversion circuit according to any one of (2) to (4), wherein a capacitance of each of the capacitors has a value corresponding to a gain of corresponding one of the two or more non-inverting input sections.
(6) A multi-value output differential amplifier, including:

an inverting input section;

an output section;

two or more non-inverting input sections;

a plurality of capacitors that are as many as the two or more non-inverting input sections and provided corresponding to the two or more non-inverting input sections, and each having a first end connected with the inverting input section;

a first switching section configured to switch a connection point of a second end of each of the capacitors between corresponding one of the two or more non-inverting input sections and the output section;

a second switching section configured to connect or disconnect a connection between the inverting input section and the output section;

a plurality of differential signal generation sections that are provided corresponding to the two or more non-inverting input sections, and each configured to generate a differential signal that is a differential between an input signal applied to corresponding one of the two or more non-inverting input sections and an input signal applied to the inverting input section; and

an amplifier section configured to amplify, at a predetermined gain, an additional value signal that is an addition of the differential output signals outputted from the differential signal generation sections, and output the amplified additional value signal to the output section.

(7) A display unit configured to drive display elements at gradation voltages generated by a level conversion circuit, the level conversion circuit including:

a multi-value output differential amplifier circuit including an inverting input section, an output section, and two or more non-inverting input sections; and

an offset cancelling circuit configured to store, on each of a plurality of capacitors, an offset voltage that arises on each of the two or more non-inverting input sections of the multi-value output differential amplifier circuit, and subtract the offset voltages from an output voltage of the output section.

(8) The display unit according to (7), further including:

a gradation voltage generation circuit configured to generate a plurality of gradation voltages corresponding to a plurality of gradation values represented by predetermined upper bits of image data; and

a selector circuit configured to select, from the plurality of gradation voltages generated by the gradation voltage generation circuit, a plurality of gradation voltages necessary to output, to the level conversion circuit, the gradation voltages corresponding to the image data, and to supply the selected gradation voltages to the respective two or more non-inverting input sections of the level conversion circuit,

wherein the level conversion circuit generates the gradation voltages corresponding to the image data from the gradation voltages supplied to the two or more non-inverting input sections, and outputs the generated gradation voltages.

It should be understood by those skilled in the art that various modifications, combinations, sub-combinations and alterations may occur depending on design requirements and other factors insofar as they are within the scope of the appended claims or the equivalents thereof.

What is claimed is:

1. A level conversion circuit, comprising:
a multi-value output differential amplifier circuit including an inverting input section, an output section, and two or more non-inverting input sections; and
an offset cancelling circuit configured to store, on each of a plurality of capacitors, an offset voltage that arises on each of the two or more non-inverting input sections of the multi-value output differential amplifier circuit, and subtract the offset voltages from an output voltage of the output section.

2. The level conversion circuit according to claim 1, wherein the offset cancelling circuit includes:
the plurality of capacitors that are as many as the two or more non-inverting input sections and provided corresponding to the two or more non-inverting input sections, and each having a first end connected with the inverting input section;
a first switching section configured to switch a connection point of a second end of each of the capacitors between corresponding one of the two or more non-inverting input sections and the output section; and
a second switching section configured to connect or disconnect a connection between the inverting input section and the output section.

3. The level conversion circuit according to claim 2, wherein the multi-value output differential amplifier circuit includes:
a plurality of differential signal generation sections that are provided corresponding to the two or more non-inverting input sections, and each configured to generate a differential signal that is a differential between an input signal applied to corresponding one of the two or more non-inverting input sections and an input signal applied to the inverting input section; and
an amplifier section configured to amplify, at a predetermined gain, an additional value signal that is an addition of the differential output signals outputted from the differential signal generation sections, and output the amplified additional value signal to the output section.

4. The level conversion circuit according to claim 2, further comprising a control section configured to control the first switching section and the second switching section to make a switching between a first state and a second state, wherein
the first state is a state in which the first switching section connects the second ends of the capacitors with the respective two or more non-inverting input sections, and in which the second switching section connects the inverting input section with the output section, and
the second state is a state in which the first switching section connects each of the second ends of the capacitors with the output section, and in which the second switching section disconnects the connection between the inverting input section and the output section.

5. The level conversion circuit according to claim 2, wherein a capacitance of each of the capacitors has a value corresponding to a gain of corresponding one of the two or more non-inverting input sections.

6. A multi-value output differential amplifier, comprising:
an inverting input section;
an output section;
two or more non-inverting input sections;
a plurality of capacitors that are as many as the two or more non-inverting input sections and provided corresponding to the two or more non-inverting input sections, and each having a first end connected with the inverting input section;
a first switching section configured to switch a connection point of a second end of each of the capacitors between corresponding one of the two or more non-inverting input sections and the output section;
a second switching section configured to connect or disconnect a connection between the inverting input section and the output section;
a plurality of differential signal generation sections that are provided corresponding to the two or more non-inverting input sections, and each configured to generate a differential signal that is a differential between an input signal applied to corresponding one of the two or more non-inverting input sections and an input signal applied to the inverting input section; and
an amplifier section configured to amplify, at a predetermined gain, an additional value signal that is an addition of the differential output signals outputted from the differential signal generation sections, and output the amplified additional value signal to the output section.

7. A display unit configured to drive display elements at gradation voltages generated by a level conversion circuit, the level conversion circuit comprising:
a multi-value output differential amplifier circuit including an inverting input section, an output section, and two or more non-inverting input sections; and
an offset cancelling circuit configured to store, on each of a plurality of capacitors, an offset voltage that arises on each of the two or more non-inverting input sections of the multi-value output differential amplifier circuit, and subtract the offset voltages from an output voltage of the output section.

8. The display unit according to claim 7, further comprising:
a gradation voltage generation circuit configured to generate a plurality of gradation voltages corresponding to a plurality of gradation values represented by predetermined upper bits of image data; and
a selector circuit configured to select, from the plurality of gradation voltages generated by the gradation voltage generation circuit, a plurality of gradation voltages necessary to output, to the level conversion circuit, the gradation voltages corresponding to the image data, and to supply the selected gradation voltages to the respective two or more non-inverting input sections of the level conversion circuit,
wherein the level conversion circuit generates the gradation voltages corresponding to the image data from the gradation voltages supplied to the two or more non-inverting input sections, and outputs the generated gradation voltages.
